(19) United States
(12) Patent Application Publication
(10) Pub. No.: US 2025/0374309 A1
(43) Pub. Date: Dec. 4, 2025

(54) SL Transmission Method, and Terminal and Non-Transitory Readable Storage Medium

(71) Applicant: VIVO MOBILE COMMUNICATION CO., LTD., Dongguan (CN)

(72) Inventors: Yuming Yang, Dongguan (CN); Zichao Ji, Dongguan (CN); Siqi Liu, Dongguan (CN)

(21) Appl. No.: 19/301,395

(22) Filed: Aug. 15, 2025

Related U.S. Application Data
(63) Continuation of application No. PCT/CN2024/076698, filed on Feb. 7, 2024.

(30) Foreign Application Priority Data
Feb. 16, 2023 (CN) 202310134073.9

(51) Int. Cl. H04W 72/40; H04W 28/26; H04W 72/23; H04W 72/542; H04W 72/566

(52) U.S. Cl. CPC H04W 72/40; H04W 28/26; H04W 72/23; H04W 72/542; H04W 72/566

(57) ABSTRACT

An SL transmission method includes obtaining, by a first terminal, LTE resource pool information, and performing, by the first terminal, NR SL transmission based on the LTE resource pool information. The LTE resource pool information includes at least one of the following; an LTE resource pool configuration, a location of a resource in an LTE resource pool, or a boundary of an LTE subframe in the LTE resource pool.

### CROSS-REFERENCE TO RELATED APPLICATIONS

This application is a Bypass Continuation Application of International Patent Application No. PCT/CN2024/076698 filed Feb. 7, 2024, and claims priority to Chinese Patent Application No. 202310134073.9 filed Feb. 16, 2023, the disclosures of which are hereby incorporated by reference in their entireties.

### BACKGROUND OF THE INVENTION

### Field of the Invention

This application pertains to the field of communication technologies, and in particular, relates to an SL transmission method, a terminal, and a non-transitory readable storage medium.

### Description of Related Art

In a frequency band in which a long term evolution (LTE) radio access technology (RAT) coexists with a new radio (NR) RAT, an NR terminal may work in a sub-carrier spacing (SCS) of 30 KHz or even higher.

### SUMMARY OF THE INVENTION

According to a first aspect, an SL transmission method is provided and is performed by a first terminal. The method includes: obtaining, by the first terminal, LTE resource pool information; and performing, by the first terminal, NR SL transmission based on the LTE resource pool information, where the LTE resource pool information includes at least one of the following: an LTE resource pool configuration, a location of a resource in an LTE resource pool, or a boundary of an LTE subframe in the LTE resource pool.

According to a second aspect, an SL transmission apparatus is provided. The apparatus includes an obtaining module and a transmission module. The obtaining module is configured to obtain LTE resource pool information, and the transmission module is configured to perform new radio NR SL transmission based on the LTE resource pool information obtained by the obtaining module, where the LTE resource pool information includes at least one of the following: an LTE resource pool configuration, a location of a resource in an LTE resource pool, or a boundary of an LTE subframe in the LTE resource pool.

According to a third aspect, a terminal is provided. The terminal includes a processor and a memory. The memory stores a program or instructions executable on the processor, and when the program or the instructions are executed by the processor, the steps of the method according to the first aspect are implemented.

According to a fourth aspect, a terminal is provided, including a processor and a communication interface. The processor is configured to obtain long term evolution LTE resource pool information, and the communication interface is configured to perform new radio NR SL transmission based on the LTE resource pool information obtained by the obtaining module, where the LTE resource pool information includes at least one of the following: an LTE resource pool configuration, a location of a resource in an LTE resource pool, or a boundary of an LTE subframe in the LTE resource pool.

According to a fifth aspect, a non-transitory readable storage medium is provided. The non-transitory readable storage medium stores a program or instructions, and when the program or the instructions are executed by a processor, the steps of the method according to the first aspect are implemented.

According to a sixth aspect, a chip is provided. The chip includes a processor and a communication interface. The communication interface is coupled to the processor. The processor is configured to run a program or instructions to implement the method according to the first aspect.

According to a seventh aspect, a computer program/program product is provided. The computer program/program product is stored in a non-transitory storage medium. The program/program product is executed by at least one processor to implement the steps of the SL transmission method according to the first aspect.

### BRIEF DESCRIPTION OF THE DRAWINGS

FIG. 1 is a schematic diagram of a structure of a communication system according to an embodiment of this application;

FIG. 2 is a first schematic flowchart of an SL transmission method according to an embodiment of this application;

FIG. 3 is a second schematic flowchart of an SL transmission method according to an embodiment of this application;

FIG. 4 is a first schematic diagram of an NR resource pool and an LTE resource pool in an SL transmission method according to an embodiment of this application;

FIG. 5 is a third schematic flowchart of an SL transmission method according to an embodiment of this application;

FIG. 6 is a fourth schematic flowchart of an SL transmission method according to an embodiment of this application;

FIG. 7 is a fifth schematic flowchart of an SL transmission method according to an embodiment of this application;

FIG. 8 is a sixth schematic flowchart of an SL transmission method according to an embodiment of this application;

FIG. 9 is a second schematic diagram of an NR resource pool and an LTE resource pool in an SL transmission method according to an embodiment of this application;

FIG. 10 is a schematic diagram of a structure of an SL transmission apparatus according to an embodiment of this application;

FIG. 11 is a first schematic diagram of a structure of a terminal according to an embodiment of this application; and

FIG. 12 is a second schematic diagram of a structure of a terminal according to an embodiment of this application.

### DESCRIPTION OF THE INVENTION

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, there may be one or more first objects. In addition, “or” in this application represents at least one of connected objects. For example, “A or B” includes three solutions: a solution 1: including A and excluding B; a solution 2: including B and excluding A; and a solution 3: including both A and B. The character “/” generally represents an “or” relationship between associated objects.

The term “indication” in this application may be either a direct indication (or an explicit indication) or an indirect indication (or an implicit indication). The direct indication may be understood as follows: A sending party explicitly notifies, in a sent indication, a receiving party of information, an operation that needs to be performed, a requested result, or other content. The indirect indication may be understood as follows: The receiving party determines corresponding information based on the indication sent by the sending party, or performs determining based on the indication sent by the sending party, and determines, based on a determining result, the operation that needs to be performed or the requested result.

It should be noted that a technology described in the embodiments of this application is not limited to a long term evolution (LTE)/LTE-advanced (LTE-A) system, and may be applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency-division multiple access (SC-FDMA) system, and another system. The terms “system” and “network” are often used interchangeably in the embodiments of this application. The technology described may be used for the systems and radio technologies described above, as well as other systems and radio technologies. The following describes a new radio (NR) system for illustrative purposes, and NR terms are used in most of the following descriptions. However, these technologies are also applicable to systems such as a 6th generation (6G) communication system other than the NR system.

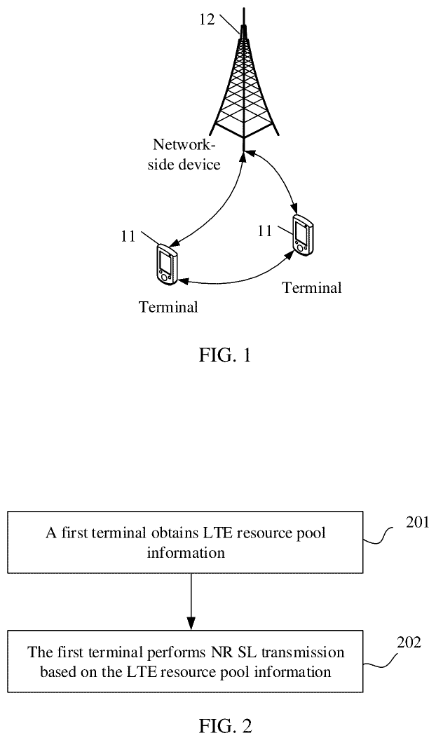

FIG. 1 is a block diagram of a wireless communication system applicable to an embodiment of this application. The wireless communication system includes a terminal 11 and a network-side device 12. The terminal 11 may be a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, a flight vehicle, vehicle user equipment (VUE), ship-mounted equipment, pedestrian user equipment (PUE), a smart home (a home device with a wireless communication function, for example, a refrigerator, a television, a laundry machine, or a furniture), a gaming console, a personal computer (PC), a teller machine, a self-service machine, or another terminal-side device. The wearable device includes a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. The vehicle user equipment may also be referred to as a vehicle-mounted terminal, a vehicle-mounted controller, a vehicle-mounted component, a vehicle-mounted chip, a vehicle-mounted unit, or the like. It should be noted that a type of the terminal 11 is not limited in this embodiment of this application. The network-side device 12 may include an access network device or a core network device. The access network device may also be referred to as a radio access network (RAN) device, a radio access network function, or a radio access network unit. The access network device may include a base station, a wireless local area network (WLAN) access point (AS), a Wireless Fidelity (WiFi) node, and the like. The base station may be referred to as a NodeB (NB), an evolved NodeB (eNB), the next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another proper term in the field. The base station is not limited to a specific technical term, provided that the same technical effect is achieved. It should be noted that in this embodiment of this application, only a base station in an NR system is used as an example for description, and a type of the base station is not limited.

The following explains and describes the terms in the embodiments of this application.

### I. Introduction to V2X

A long term evolution (LTE) system supports sidelink (which is referred to as SL for short) transmission, that is, data transmission is directly performed between terminals (User Equipment, UE) at a physical layer. LTE sidelink is based on broadcast for communication, and is not applicable to other more advanced V2X services although the LTE sidelink can be used to support basic security-type communication of vehicle to everything (V2X). A 5G NR system supports a more advanced sidelink transmission design, such as unicast, multicast, or multicast, thereby supporting more comprehensive service types. The long term evolution (LTE) system supports sidelink from Release 12, to perform direct data transmission between terminal user equipment (UE) without using a network device.

### II. Selection of an SL Transmission Resource

Determining a resource pool is a prerequisite for a terminal to perform communication and is a basis for all, and therefore may be performed at the earliest time. Selecting a transmission resource is the last step of a resource selection process, and is performed by a media access control (MAC) layer. The rest all belong to a physical layer process of the resource selection process. Steps are as follows:

Step 1: Determine a candidate resource selection window.

Step 2: Determine a detection window location corresponding to the selection window.

Step 3: Set a priority and an intermediate parameter corresponding to a reference signal received power (RSRP) threshold.

Step 4: Initialize a candidate resource set as all possible candidate resources in the resource selection window.

Step 5: Exclude a candidate resource in a resource selection window corresponding to a resource that is not detected due to a half-duplex problem or the like.

Step 6: Exclude a candidate resource, in the resource selection window, that meets an excluding condition and that is reserved by another terminal.

Step 7: Determine whether a quantity of remaining candidate resources in the candidate resource set meets a requirement; and if the quantity of remaining candidate resources in the candidate resource set does not meet the requirement, increase the intermediate parameter set in step 3, and then go back to step 4 to perform a resource selection step.

With reference to the accompanying drawings, an SL transmission method and apparatus, a terminal, and a non-transitory readable storage medium that are provided in the embodiments of this application are described in detail below by using some embodiments and application scenarios thereof.

In a background in which an NR terminal and an LTE terminal coexist, a possibility that the NR terminal works in an SCS of 30 KHz or even higher needs to be considered. When the NR terminal works in a higher SCS, there may be a plurality of NR transmissions in a time period of an LTE subframe. However, there is only one automatic gain control (AGC) symbol of LTE. Therefore, power of NR transmissions in the latter half of the LTE subframe may not be in an AGC adjustment range of LTE, and reliability of LTE transmission is affected.

A solution in a current technology is to introduce a method for sending in consecutive slots. For example, a multi-slots technology currently discussed in SLU is directly referenced. For example, transmission of a terminal no longer occupies only one slot, but continuously occupies a plurality of slots, so that power of NR transmission in a time period of an LTE subframe remains unchanged, thereby avoiding impact on LTE transmission. However, the multi-slots technology does not emphasize a boundary of NR transmission, which needs to be resolved in coexistence, because if a boundary of multi-slots transmission is not aligned with that of an LTE subframe, the foregoing problem can still be caused.

To resolve the foregoing technical problem, embodiments of this application provide an SL transmission method, including: obtaining, by a first terminal, LTE resource pool information; and performing, by the first terminal, NR SL transmission based on the LTE resource pool information, where the LTE resource pool information includes at least one of the following: an LTE resource pool configuration, a location of a resource in an LTE resource pool, or a boundary of an LTE subframe in the LTE resource pool. In this way, NR SL transmission may be performed based on a configuration or resource information of the LTE resource pool. Therefore, it can be ensured that a resource for performing NR SL transmission and an LTE subframe completely overlap or completely do not overlap in time domain, thereby preventing NR SL transmission from affecting LTE SL transmission.

For example, because the resource for performing NR SL transmission and the LTE subframe completely overlap or completely do not overlap in time domain, NR SL transmission does not affect LTE SL transmission regardless of whether an LTE RAT and an NR RAT share a same frequency. In this way, transmission performance can be improved.

An embodiment of this application provides an SL transmission method. As shown in FIG. 2, the SL transmission method provided in this embodiment of this application may include step 201 and step 202.

Step 201: A first terminal obtains LTE resource pool information.

The LTE resource pool information includes at least one of the following: an LTE resource pool configuration, a location of a resource in an LTE resource pool, or a boundary of an LTE subframe in the LTE resource pool.

It may be understood that the location of the resource in the LTE resource pool refers to a location of a resource in the LTE resource pool. The location of the resource in the LTE resource pool may be represented by using an index of an LTE subframe, a boundary of an LTE subframe, or the like.

In this embodiment of this application, the LTE resource pool information may indicate a resource in the LTE resource pool.

Optionally, a boundary of a subframe may include a start boundary and an end boundary, where the start boundary is also referred to as a time domain start location, and the end boundary is also referred to as a time domain end location.

It may be understood that, after a location of a resource in the LTE resource pool is determined, for example, whether the resource overlaps with an NR resource pool in time domain or frequency domain, and resources overlapping with the resource, and a boundary of each subframe in the LTE resource pool, an NR terminal may use a resource that completely overlaps or completely does not overlap with an LTE subframe in time domain, thereby avoiding impact on LTE transmission.

Step 202: The first terminal performs NR SL transmission based on the LTE resource pool information.

It should be noted that “the first terminal performs NR SL transmission based on the LTE resource pool information” may be understood as follows: The first terminal determines a transmission resource (for example, the following first resource) based on the LTE resource pool information, and performs NR SL transmission by using the transmission resource.

It should be noted that, the transmission resource used by the first terminal meets a first condition. For description of the first condition, refer to related description of the first condition in the following embodiment.

In the SL transmission method provided in this embodiment of this application, because the first terminal may obtain the LTE resource pool information, and perform NR SL transmission based on the LTE resource pool information, it can be ensured that a resource for performing NR SL transmission and an LTE subframe completely overlap or completely do not overlap in time domain, thereby preventing NR SL transmission from affecting LTE SL transmission.

Optionally, step 201 may be implemented by using the following step 201a or step 201b.

Step 201a: The first terminal receives the LTE resource pool information.

Optionally, the LTE resource pool information may be sent by an LTE terminal or an NR terminal.

Optionally, when the first terminal includes an LTE module, the first terminal may obtain the LTE resource pool information by using the LTE module.

Step 201b: The first terminal determines the LTE resource pool information based on first information.

The first information includes at least one of the following:
(i) an LTE time division duplex (TDD) configuration, where for example, the first terminal determines configuration information, boundary information, and other LTE resource pool information of an LTE subframe by reading the LTE TDD configuration;
(ii) an LTE synchronization signal location, where for example, the first terminal may determine a location, a boundary, and other LTE resource pool information of an LTE subframe by using the LTE synchronization signal location, because the LTE synchronization signal location is relatively fixed; and optionally, the LTE synchronization signal location may include at least one of the following: a detected LTE synchronization signal location or a configured LTE synchronization signal location;
(iii) an Inter-UE coordination (IUC) indication, where for example, an NR terminal without an LTE module may determine the LTE resource pool information by using related information indicated by the IUC sent by an NR terminal with an LTE module; or
(iiii) a first measurement quantity, where the first measurement quantity may include at least one of the following: a received signal strength indication (RSSI) or an RSRP.

Optionally, the first terminal may first obtain the first information. For example, the first terminal receives the first information, and then determines the LTE resource pool information based on the first information.

In this way, because the first terminal may directly receive the LTE resource pool information or determine the LTE resource pool information based on the first information, flexibility of obtaining the LTE resource pool information may be improved.

Optionally, the first information includes the first measurement quantity. The foregoing step 201a may be implemented by using the following step 201a1.

Step 201al: The first terminal determines a boundary of an LTE subframe in the LTE resource pool based on the first measurement quantity.

For example, the first terminal determines a location of a guard symbol through an RSSI. In this case, energy of the guard symbol is different from energy of another symbol, and therefore the boundary of the LTE subframe is determined.

In this way, the boundary of the LTE subframe in the LTE resource pool can be more accurately determined through an RSSI or an RSRP, so that it can be ensured that NR SL transmission does not affect LTE SL transmission.

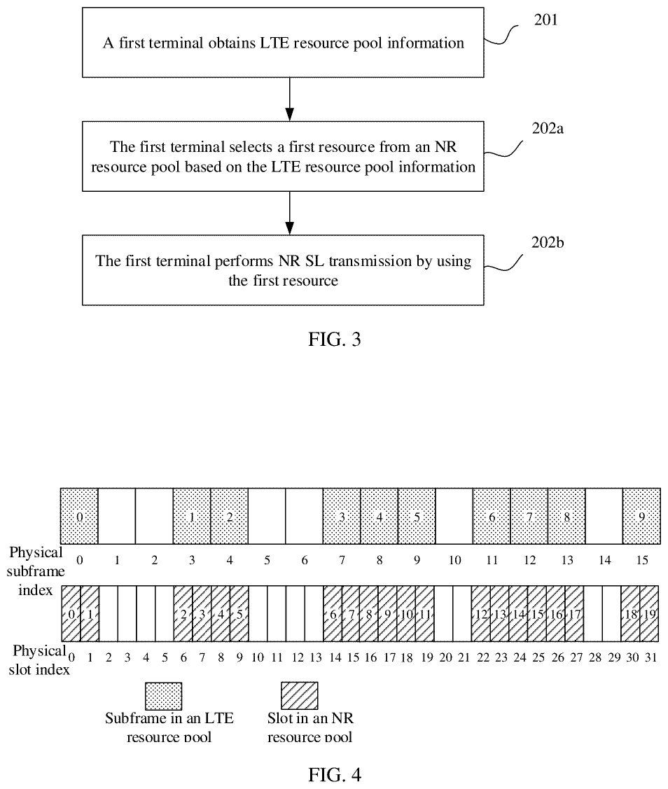

Optionally, with reference to the foregoing FIG. 2, as shown in FIG. 3, the foregoing step 202 may be implemented by using the following step 202a and step 202b.

Step 202a: The first terminal selects a first resource from an NR resource pool based on the LTE resource pool information.

Step 202b: The first terminal performs NR SL transmission by using the first resource.

The first resource meets a first condition, and the first condition may include at least one of the following that:
the first resource is not time-domain multiplexed with all LTE subframes in the LTE resource pool;
the first resource is fully time-domain multiplexed with an LTE subframe in the LTE resource pool;
the first measurement quantity of the first resource is less than or equal to a first threshold, and the first measurement quantity includes at least one of the following: an RSSI or an RSRP;
an index of a start slot of the first resource meets a first rule;
an index of an end slot of the first resource meets a second rule;
the first resource does not conflict with a reserved resource; or
an AGC symbol in the start slot of the first resource is time-domain multiplexed with an AGC symbol in an LTE subframe in the LTE resource pool.

It may be understood that, when the first resource is not time-domain multiplexed with all the LTE subframes in the LTE resource pool, a time domain of the first resource does not overlap with that of the LTE resource pool, and LTE transmission is not affected.

It may be understood that, when the first resource is fully time-domain multiplexed with one or more LTE subframes in the LTE resource pool, NR transmission does not occur only in a partial location of the LTE subframe in this case, which does not cause an AGC adjustment failure of LTE and does not affect LTE transmission.

It may be understood that, when the first measurement quantity is less than or equal to the first threshold, it may be considered that interference between a current terminal and another LTE terminal is very small, and impact on LTE transmission may be ignored.

In this embodiment of this application, the first rule includes that a remainder obtained by dividing an index by k is q, and the second rule includes that a remainder obtained by dividing an index by k is p, where k is determined by a ratio of a first SCS to a second SCS, the first SCS is an SCS used by the first terminal, the second SCS is an SCS used by an LTE RAT, and k, p, and q are integers. It should be noted that p and q are different.

Optionally, p is usually q+k−1, and q is a non-0 integer.

Optionally, the first SCS may include any one of the following: 15 KHz, 30 KHz, 60 KHz, or 120 KHz. The second SCS may be 15 KHz.

Optionally, k may be any one of the following:
the ratio of the first SCS to the second SCS;
a multiple of the ratio of the first SCS to the second SCS; or
any number that is less than the ratio of the first SCS to the second SCS and that is to transmission to a plurality of destination terminals by using resources with same power.

For example, assuming that k=the ratio of the first SCS to the second SCS, q=0, p=1, and k=2. In this case, if the first SCS is 30 KHz, and the second SCS is 15 KHz, k=2. Therefore, for an index of a logical slot shown in FIG. 4, even indexes such as 0, 2, 4, and 6 in FIG. 4 meet the first rule, and logical indexes 1, 3, 5, and 7 in FIG. 4 meet the second rule. The logical index is also referred to as an index of a physical slot.

Optionally, a unit of the first resource may be one slot or k slots.

Optionally, when a start slot of the first resource meets the first rule, if the first resource is time-domain multiplexed with an LTE subframe, an AGC symbol of the first resource is aligned with an AGC symbol of the LTE subframe. When an AGC symbol of a start resource is aligned, the LTE terminal considers power impact of NR transmission when adjusting AGC, thereby adjusting to a proper AGC range.

It should be noted that, because SCSs of the NR terminal and the LTE terminal are different, symbol alignment herein does not mean not complete alignment in time domain, but mean start location alignment of a symbol.

Optionally, when an end slot of the first resource meets the second rule, if the start slot also meets the first rule, the first resource is multiplexed with the LTE subframe time domain, so that, the LTE terminal considers power impact of NR transmission when adjusting AGC, thereby adjusting to a proper AGC range.

Optionally, “reserved resource” in “not conflicting with a reserved resource” may be at least one of the following: a reserved resource of the first terminal or a reserved resource of another NR terminal or LTE terminal.

Optionally, the first SCS may be an SCS used by the first terminal to perform NR SL transmission.

For example, the first terminal performs NR SL transmission by using the first SCS and the first resource.

Optionally, the first terminal may determine the NR resource pool based on the LTE resource pool information.

Optionally, the NR resource pool meets any one of the following:
(1) the NR resource pool is fully time-domain multiplexed with the LTE resource pool;
(2) the NR resource pool is partially time-domain multiplexed with the LTE resource pool; or
(3) the NR resource pool is not time-domain multiplexed with the LTE resource pool.

Optionally, when the NR resource pool and the LTE resource pool can be fully multiplexed in time domain, as shown in FIG. 4, the NR resource pool and the LTE resource pool are completely aligned in time domain. For example, the LTE resource pool and the NR resource pool completely overlap in at least time domain. In this case, an NR synchronization signal and an LTE synchronization signal also need to be multiplexed in time domain, thereby facilitating implementation of a requirement of complete overlapping. In this case, a slot whose index meets the first rule in the NR resource pool is necessarily aligned with a start location of an LTE subframe in the LTE resource pool.

Optionally, in (2), a resource that is in the NR resource pool and that overlaps in time domain with a resource in the LTE resource pool may meet the following condition:
a start slot meets the first rule;
an AGC symbol in the start slot is aligned with an AGC symbol in an LTE subframe in the LTE resource pool;
an AGC symbol in the start slot is aligned with an AGC symbol in an LTE subframe in the LTE resource pool;
a start location of a slot whose index meets the first rule matches a start location of an LTE subframe in the LTE resource pool; or
an end slot meets the second rule.

It may be understood that in (2), it is not required that the LTE resource pool and the NR resource pool completely overlap or completely do not overlap in time domain, but requires to ensure that in a part in which the two resource pools overlap, a start boundary of an LTE subframe in the LTE resource pool always corresponds to a start boundary of a slot that meets the first rule. For example, it is considered by default that a logical slot of the NR resource pool corresponds to that of the LTE resource pool. For example, as shown in FIG. 4, a slot 0, a slot 1, a slot 2, and a slot 3 of the NR resource pool correspond to a subframe 0 of the LTE resource pool in time domain.

In this way, the first terminal may select, based on the LTE resource pool information from the NR resource pool, the first resource that meets the first condition, and perform NR SL transmission by using the first resource. Therefore, NR SL transmission of the first terminal can be prevented from affecting LTE SL transmission of an LTE terminal or an LTE device.

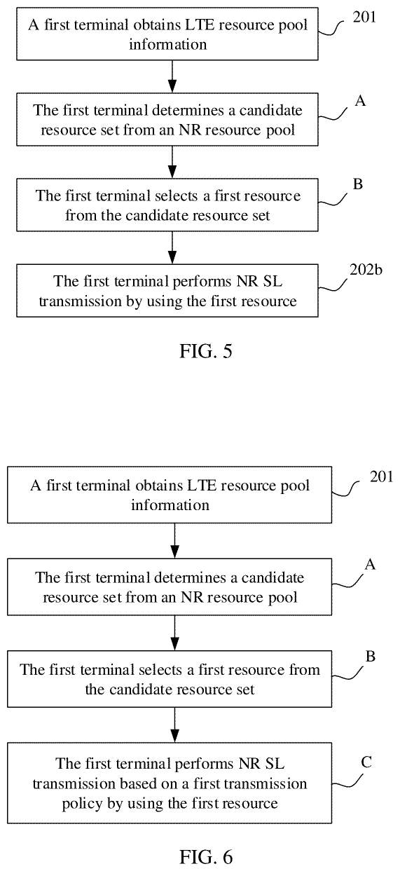

Optionally, with reference to FIG. 3, as shown in FIG. 5, the foregoing step 202a may be implemented by using the following step A and step B.

Step A: The first terminal determines a candidate resource set from the NR resource pool.

A unit of a candidate resource in the candidate resource set is k slots or one slot.

Optionally, when the unit of the candidate resource is k slots, an index of a start slot of the candidate resource meets the first rule.

Optionally, that the first terminal determines the candidate resource set from the NR resource pool may be understood as follows: The first terminal determines a resource selection window from the resource pool to determine a candidate resource, and then initializes the candidate resource set as a set that includes all or some candidate resources.

Optionally, the candidate resource set may include at least one of the following: a candidate resource with a unit of one slot, or a candidate resource with a unit of k slots.

Optionally, the unit of the candidate resource in the candidate resource set is determined by second information. The second information may include at least one of the following: a second measurement quantity, a downlink control information (DCI) indication, a sidelink control information (SCI) indication, a resource pool preconfiguration, a resource pool configuration, a network preconfiguration, a network configuration, a synchronization source type, synchronization signal strength, or a first indication. In actual implementation, the second information may further include whether the resource selection window overlaps with the LTE resource pool in time domain or whether an overlapping proportion is greater than a threshold.

Optionally, the second measurement quantity may include at least one of the following: a channel busy ratio (CBR), a channel occupancy ratio (CR), an SCI detection amount, an RSRP, an RSSI, or a synchronization signal reference signal received power (SS-RSRP).

For example, the second measurement quantity includes a CBR/CR measured by an LTE module/LTE terminal.

For example, the second measurement quantity includes a CBR/CR for the LTE RAT.

Optionally, the first indication may include at least one of an IUC conflict indication or a coexistence indication. The IUC conflict indication may be used to indicate that NR SL transmission of at least one NR terminal conflicts with LTE SL transmission. The coexistence indication is used to indicate that the at least one NR terminal or LTE terminal coexists with an LTE terminal.

For example, when the first indication is the coexistence indication, another LTE/NR terminal indicates that the another LTE/NR terminal coexists with LTE UE. For example, a terminal may notify, in a form of broadcast, multicast, unicast, or the like, another terminal of a case that the another terminal coexists with LTE SL, that is, the coexistence indication. A transmission manner of the conflict indication is the same as that of the coexistence indication.

Step A may be performed by a physical layer (PHY) in the first terminal.

For example, the physical layer selects a candidate resource set based on a resource selection window of the physical layer, and reports the candidate resource set to a MAC layer.

The following describes a method for determining the unit of the candidate resource unit based on the second information.

For example, in a case that the second measurement quantity is greater than or equal to a third threshold, the unit of the candidate resource is k slots; and in a case that the second measurement quantity is less than the third threshold, the unit of the candidate resource is 1 slot.

For example, when a quantity of LTE terminals becomes smaller, the NR terminal (such as the first terminal) tends to maintain a same structure as the R16 or R17 NR terminal, which facilitates backward compatibility.

It may be learned that the second measurement quantity may reflect whether an environment includes an LTE terminal, a quantity of LTE terminals in the environment, and a distance between the LTE terminal and the NR terminal in the environment.

For example, in a case that a first indication field added to the DCI indication is 1, the unit of the candidate resource is k slots; and in a case that the first indication field added to the DCI indication is 0, the unit of the candidate resource is 1 slot.

For example, in a case that a second indication field in the SCI is 1, the unit of the candidate resource is k slots; and in a case that the second indication field in the SCI is 0, the unit of the candidate resource is 1 slot.

For example, in a case that the synchronization source type indicates that the NR terminal uses the LTE terminal as a synchronization source, the unit of the candidate resource is k slots; and when the synchronization source type indicates that the NR terminal uses the LTE terminal as a non-synchronization source, the unit of the candidate resource is one slot.

It may be understood that, if the NR terminal can select the LTE terminal as the synchronization source, it indicates that there are a relatively large quantity of LTE terminals in a system, it tends to ensure that no impact is caused on LTE transmission; otherwise, it may be more likely to be compatible with an NR terminal of another version.

For example, in a case that the synchronization signal strength is greater than or equal to a fourth threshold, the unit of the candidate resource is k slots; and in a case that the synchronization signal strength is less than the fourth threshold, the unit of the candidate resource is one slot.

It may be understood that, if the NR terminal detects that strength of an LTE synchronization source is relatively high, it indicates that there are a relatively large quantity of LTE terminals in a system, it tends to ensure that no impact is caused on LTE transmission; otherwise, it may be more likely to be compatible with an NR terminal of another version.

Optionally, “SCI detection amount” may be an amount of detected LTE SCI.

For example, the SCI detection amount is an amount of LTE SCI detected by the first terminal.

It may be understood that, if the NR terminal detects that there are a large amount of LTE SCI in a system, it indicates that there are a relatively large quantity of LTE terminals around, it tends to ensure that no impact is caused on LTE transmission; otherwise, it may be more likely to be compatible with an NR terminal of another version.

For example, whether the resource selection window overlaps with the LTE resource pool in time domain or whether the overlapping proportion is greater than the threshold. It may be understood that, if the resource selection window does not overlap with the LTE resource pool in time domain, it indicates that none of resources selected in this case affects LTE transmission. Therefore, a resource selection manner in which the unit of the candidate resource is 1 slot may be selected, to be compatible with an NR terminal of another version. When the overlapping proportion is less than a specific threshold, a resource selection manner in which the unit of the candidate resource is 1 slot may also be selected. On the contrary, a resource selection manner in which the unit of the candidate resource is k slots is selected.

It should be noted that, when the candidate resource is determined, the following method may be used, that is, the unit of the candidate resource is k slots in a part that overlaps with the LTE resource pool, and the unit of the candidate resource is 1 slot in a part that does not overlap with the LTE resource pool.

In this way, the unit of the candidate resource in the candidate resource set may be determined by using a plurality of pieces of information, so that flexibility of determining the unit of the candidate resource can be improved.

Step B: The first terminal selects the first resource from the candidate resource set.

Optionally, the first terminal may select the first resource from the candidate resource set based on the LTE resource pool information, the first rule, or the second rule.

Optionally, step B may be performed by the MAC layer in the first terminal.

For example, the MAC layer may select, based on the LTE resource pool information, the first rule, or the second rule, the first resource from the candidate resource set reported by the PHY layer.

In this way, the first terminal may first determine, from the NR resource pool, a candidate resource set whose candidate resource has a unit of one slot or k slots, that is, the first terminal may determine, based on an actual transmission requirement, a candidate resource set that meets the transmission requirement of the first terminal, and then select a proper resource from the candidate resource set for NR SL transmission. In this way, accuracy of selecting a resource by the first terminal can be improved. Alternatively, the first terminal may determine, as the first resource based on factors such as an actual transmission requirement and whether a candidate resource overlaps with the LTE resource pool, a candidate resource that includes one slot or a candidate resource that includes k slots.

Optionally, the foregoing step B may be implemented by using the following step B1 or step B2.

Step B1: In a case that the unit of the candidate resource in the candidate resource set is k slots, the first terminal determines a candidate resource that meets a second condition in the candidate resource set as the first resource.

The second condition may include at least one of the following that:
the candidate resource is fully time-domain multiplexed with an LTE subframe in the LTE resource pool;
an index of a start slot meets the first rule;
an index of an end slot meets the second rule; or
an AGC symbol in the start slot is time-domain multiplexed with an AGC symbol in an LTE subframe in the LTE resource pool.

It should be noted that, in this embodiment of this application, if an NR resource is fully time-domain multiplexed with an LTE subframe in the LTE resource pool, a time domain boundary of the NR resource is aligned with a time domain boundary of the LTE subframe, an index of a start slot of the NR resource meets the first rule, and an index of an end slot of the NR resource meets the second rule, or an AGC symbol in the start slot of the NR resource is aligned with an AGC symbol in the LTE subframe.

It should be noted that in this embodiment of this application, to facilitate multiplexing of the first resource and the LTE subframe that are selected in a resource selection process, a concept of an aggregated slot or a logical subframe may be introduced on an NR side. For example, the aggregated slot is a plurality of consecutive slots, and the logical subframe means that a resource in the NR resource pool is virtually numbered based on a length of an LTE subframe. For example, in FIG. 4, every two slots corresponding to each LTE subframe in the NR resource pool is considered as a logical subframe or an aggregated slot. Therefore, a specific logical subframe or aggregated slot may be directly selected during selection.

For example, for resource selection of the aggregated slot, if the first resource is fully time-domain multiplexed with an LTE subframe, an AGC symbol in a start slot of the first resource is time-domain multiplexed with an AGC symbol in the LTE subframe, and an index of the start slot of the first resource meets the first rule, or an index of the end slot of the first resource meets the second rule.

Step B2: In a case that the unit of the candidate resource in the candidate resource set is one slot, the first terminal determines k consecutive candidate resources in the candidate resource set as the first resource.

For example, the candidate resource is still selected as a source including only one slot. The MAC layer may select, based on the LTE resource pool information and the first rule, k consecutive candidate resources from the candidate resource set reported by the physical layer, where the k candidate resources meet a granularity of one slot. In this case, an AGC symbol of the 1-st candidate resource in the k candidate resources is time-domain multiplexed with an AGC symbol in an LTE subframe; an index of the 1-st candidate resource in the k candidate resources meets the first rule; or an index of the last candidate resource in the k candidate resources meets the second rule.

Optionally, the k candidate resources in step B2 meet a third condition, and the third condition may include at least one of the following that:
an AGC symbol of the 1-st candidate resource in the k candidate resources is time-domain multiplexed with an AGC symbol in an LTE subframe in the LTE resource pool;
an index of the 1-st candidate resource in the k candidate resources meets the first rule;
an index of the last candidate resource in the k candidate resources meets the second rule; or
the k candidate resources are not time-domain multiplexed with all the LTE subframes in the LTE resource pool.

In this way, when the unit of the candidate resource in the candidate resource set is one slot, the first terminal may select, from the candidate resource set as transmission resources, k candidate resources that do not overlap in time domain with all the LTE subframes in the LTE resource pool, where in the candidate resources, an index of the 1-st candidate resource meets the first rule, an index of the 2-nd candidate resource meets the second rule, an AGC symbol of the 1-st candidate resource is time-domain multiplexed with an AGC symbol in an LTE subframe in the LTE resource pool. Therefore, it may be ensured that NR SL transmission of the first terminal does not affect LTE SL transmission.

It should be noted that, the first resource selected in the manner of step B1 and step B2 should be further met that the first resource does not conflict with a reserved resource.

It may be understood that, although the first resource does not adversely affect AGC of an LTE subframe, first resource may still cause interference to LTE transmission. Therefore, when the first resource is selected, it is ensured that the first resource does not conflict with a reserved resource of another terminal, or causes relatively small interference.

In this way, when units of the candidate resource are different, the first terminal may use different transmission resource selection manners, so that flexibility and accuracy of a transmission resource can be improved.

Optionally, with reference to FIG. 5, as shown in FIG. 6, the foregoing step 202b may be implemented by using the following step C.

Step C: The first terminal performs NR SL transmission based on a first transmission policy by using the first resource.

The first transmission policy may include at least one of the following that:
(i) A gap symbol between slots is used to send a physical sidelink shared channel PSSCH or virtual data. It may be understood that when the terminal continuously performs transmission in a plurality of slots, a gap symbol between slots loses an original function, and even an AGC problem may occur in LTE transmission corresponding to the symbol. Therefore, the signal may be used to transmit data or the like, to improve resource utilization, or prevent a channel from being lost on an unlicensed frequency band.
(ii) Transport blocks TBs in different slots are sent to a same destination terminal. It may be understood that, if the first terminal sends transport blocks to a destination terminal, transmit/receive conversion does not need to be performed in this case, and transmission power in different slots may remain consistent, so that an AGC problem does not occur.
(iii) When TBs in different slots are sent to different destination terminals, transmit power of the TBs remains consistent. It may be understood that if the requirement (iii) is met, an AGC problem no longer needs to be considered, except for a case related to a PSFCH.

Optionally, step C may be performed after step 202a, or may be performed after step B.

Optionally, in a case that TBs in different slots are sent to a same destination terminal, another slot that is in the first resource and that is different from a slot in which initially transmitted data is sent is used for blind retransmission.

In this way, because the first terminal may perform NR SL transmission based on the first transmission policy by using the first resource, transmission accuracy may be improved.

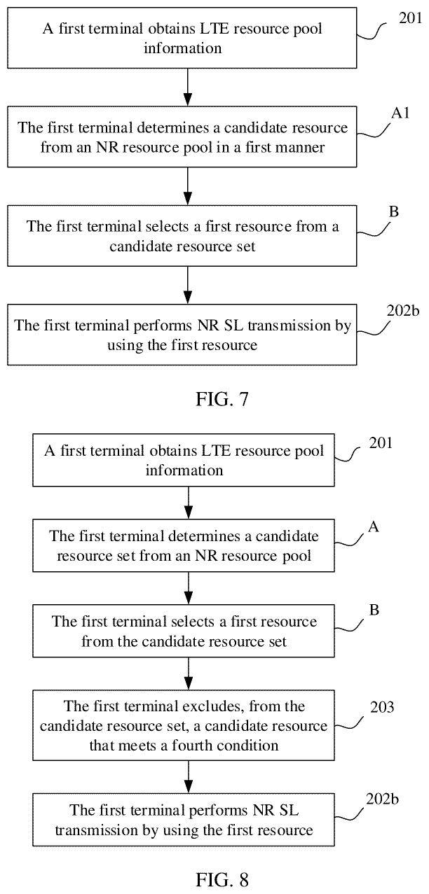

Optionally, with reference to FIG. 5, as shown in FIG. 7, the foregoing step A may be implemented by using the following step A1.

Step A1: The first terminal determines a candidate resource from the NR resource pool in a first manner.

In this embodiment of this application, the first manner may include at least one of the following that:
the candidate resource includes L subchannels in k slots;
in a case that the NR resource pool is fully time-domain multiplexed with the LTE resource pool, the candidate resource includes L subchannels in k consecutive slots with a start slot having an index t;
in a case that the NR resource pool is not time-domain multiplexed with the LTE resource pool, the candidate resource includes L subchannels in one slot; or
in a case that the NR resource pool is partially time-domain multiplexed with the LTE resource pool, a candidate resource in a first time domain range includes L subchannels in k consecutive slots with a start slot having an index r, and a candidate resource in a second time domain range includes L subchannels in one slot.

The first time domain range is a time domain range in which the NR resource pool and the LTE resource pool overlap in time domain; and
the second time domain range is a time domain range in which the NR resource pool and the LTE resource pool do not overlap in time domain, t, r, and L all are integers greater than or equal to 0, and r and t meet the first rule.

For example, for an NR resource pool time-domain multiplexed with the LTE resource pool, the candidate resource is initialized as L subchannels in k slot, or initialized as L subchannels in k slot whose start slot is a slot t and whose end slot is a slot (t+k−1).

For an NR resource pool that is not time-domain multiplexed with the LTE resource pool, the candidate resource is initialized as L subchannels in any slot, which aims to make a non-overlapping part closer to an existing design, and resource selection is also more flexible.

It may be understood that, the first terminal may determine, as the first resource based on factors such as an actual transmission requirement and whether a candidate resource overlaps with the LTE resource pool, a candidate resource that includes one slot or a candidate resource that includes k slots.

In this way, because the first terminal may determine the candidate resource from the NR resource pool in the first manner to obtain the candidate resource set, the resource in the candidate resource set does not affect LTE SL transmission.

Optionally, with reference to FIG. 5, as shown in FIG. 8, before step B, the SL transmission method provided in this embodiment of this application may further include the following step 203.

Step 203: The first terminal excludes, from the candidate resource set, a candidate resource that meets a fourth condition.

In this embodiment of this application, the fourth condition may include at least one of the following (a) to (g) that:

(a) A slot of the candidate resource includes a slot of a reserved resource indicated by second SCI.

For example, for SCI received in a slot i, if a reserved resource indicated by the SCI is located in a slot of a candidate resource, the candidate resource is excluded, where i is an integer greater than or equal to 0.

(b) The candidate resource multiplexes a same LTE subframe as the reserved resource indicated by the second SCI.

It may be understood that “the candidate resource multiplexes a same LTE subframe as a reserved resource indicated by the second SCI” is also referred to as time-domain multiplexing a same LTE subframe as the reserved resource indicated by the second SCI, or the two resources correspond to a same predefined boundary, or the two resources overlap in time domain.

(c) The candidate resource locates in a same aggregated resource as the reserved resource indicated by the second SCI.

Optionally, the aggregated resource may include a plurality of consecutive slots, for example, NR resources in k consecutive slots. Alternatively, the aggregated resource may be resources in a plurality of consecutive slots that completely overlap with an LTE subframe in time domain.

Optionally, the aggregated resource may be predefined in a protocol, preconfigured by a network, configured by a network, or determined by a terminal.

For example, the NR module determines a location of an LTE subframe based on the LTE configuration information obtained by the LTE module, and determines the aggregated resource and an index of the aggregated resource based on the location of the LTE subframe.

(d) The candidate resource corresponds to a same start slot as the reserved resource indicated by the second SCI, where an index of the start slot of the resource meets the first rule.

For example, a start slot of the candidate resource is a slot 2, and a start slot of the reserved resource indicated by the second SCI is also the slot 2.

Optionally, the start slot in (d) is determined by a terminal.

For example, the NR module determines a location of an LTE subframe based on the LTE configuration information obtained by the LTE module, and determines the location of the start slot based on the location of the LTE subframe, for example, a slot that meets slot index mod k=0 is used as the start slot.

(e) The candidate resource corresponds to a same slot range as the reserved resource indicated by the second SCI, where quotients obtained by dividing indexes of slots in the same slot range by k are the same.

Optionally, the slot range may be [x, x+k*u−1], where x is an integer greater than or equal to 0, and u is a positive integer.

For example, assuming that an index of a slot of the reserved resource indicated by the SCI is 2, and that an index of a physical slot of the NR resource pool is aligned with an index of a physical subframe of the LTE resource pool, a candidate resource that is in the candidate resource and that is located in a slot range [0, 3]; or Alternatively, a candidate resource partially multiplexed in a time domain range and the slot range [0, 3] may be excluded.

In actual implementation, if an index of a candidate resource, after subtracting a value and dividing by k, results in a same quotient as an index of the reserved resource indicated by the SCI, the candidate resource may be excluded. It may be understood that during alignment with a start slot of an LTE subframe or the 1-st slot of an aggregated slot or a logical subframe, a remainder after dividing by k may not be equal to 0, but is equal to a value less than k. Therefore, to calculate a slot that belongs to a same aggregated slot or a logical subframe, the value needs to be subtracted from an index before calculation.

(f) The candidate resource is partially time-domain multiplexed with an LTE subframe part in the LTE resource pool.

(g) The candidate resource is at least partially time-domain multiplexed with a first reserved resource indicated by first SCI, where an RSRP of the first SCI is greater than or equal to a second threshold, and the first reserved resource is not time-domain multiplexed with all the LTE subframes in the LTE resource pool.

For example, if the first terminal receives SCI in a slot i, and a reserved resource indicated by the SCI does not overlap the LTE resource pool in time domain, a candidate resource that overlaps with or that is time-domain multiplexed with the reserved resource is not excluded. Alternatively, when an RSRP of the SCI is greater than or equal to the second threshold, a candidate resource that overlaps with or that is multiplexed with the reserved resource is excluded, where i is an integer greater than or equal to 0. It should be noted that, if the RSRP of the SCI is less than the second threshold and is greater than or equal to a third threshold, a resource does not need to be excluded for the reserved resource indicated by the SCI.

In this embodiment of this application, both the second SCI and the first SCI is SCI detected by the first terminal.

Optionally, the second SCI may be SCI whose RSRP is greater than or equal to the third threshold.

Optionally, the second SCI may be LTE SCI or NR SCI, and the first SCI may be LTE SCI or NR SCI.

The SCI in this embodiment of this application may be LTE SCI or NR SCI.

Optionally, the first terminal may initialize candidate resources for transmission as L subchannels in k slots whose indexes are consecutive, and then the first terminal excludes, from the candidate resource set, a candidate resource partially time-domain multiplexed with an LTE subframe. In other words, a candidate resource that is not in the LTE resource pool and a resource that is fully time-domain multiplexed with the LTE subframe are left, that is, alignment of time domain boundaries is ensured during construction of candidate resources.

It should be noted that, when the NR resource pool and the candidate resource set before initialization partially overlap with the LTE resource pool in time domain, the candidate resource may be aligned with the LTE subframe by using a resource excluding process.

Optionally, when the reserved resource of the first terminal is not multiplexed with an LTE subframe in the LTE resource pool, only a candidate resource that conflicts with the reserved resource may be excluded (corresponding to a case that two types of candidate resources exist). If the reserved resource does not conflict with a time domain of an LTE resource, a resource does not need to be excluded in a manner of an aggregated slot.

It should be noted that a candidate resource excluding process may occur in step 4, step 5, step 6, or step 7 of resource selection, or after step 7 and before reporting to the MAC layer. Reference may be made to step 1 to step 7 shown in the foregoing term explanation part. Optionally, the resource excluding process is performed by the PHY layer.

In this way, after initializing the candidate resource set, the first terminal may exclude a candidate resource in the candidate resource set based on a fourth condition. Therefore, it can be ensured that all candidate resources reserved in the candidate resource set meet the fourth condition, and the resources that meet the fourth condition does not affect a resource for LTE SL transmission. Therefore, it can be ensured that a transmission resource finally determined by the first terminal does not affect LTE SL transmission.

Optionally, a resource indication of the first terminal meets at least one of the following that:
(i) At least one of first-stage SCI or second-stage SCI is set in a start slot of a transmission resource. In other words, actual sending is still performed in a lower SCS. Therefore, in this case, control information may not need to be sent in each slot.
(ii) A time domain location indicated by a time resource indication value (TRIV) carried in SCI or a reserved time domain location is a time domain location of a candidate resource indicated by the SCI.

In other words, the TRIV carried in the SCI indicates an index of an aggregated resource or a logical subframe.
(iii) The SCI carries a second indication, where the second indication is used to indicate that a current slot is located in which slot of the candidate resource. The second indication is used by a receive end (for example, the first terminal) to determine a boundary of the candidate resource, so that it is convenient to exclude a resource. The corresponding boundary is transparent to the physical layer and is performed by the MAC layer of the terminal.
(iiii) A reservation period T of the first terminal meets at least one of the following: T=Q*j*k, or T=j*k.

Q may include one of a step in the TDD configuration and an LTE-configurable reservation period, and j is an integer not less than 0. In this way, an LTE terminal or an LTE module may detect, when performing sorting based on an RSSI, an RSSI of a resource occupied by NR, to make it less easily to select a resource in the NR resource pool.

It may be understood that, when the reservation period T of the first terminal meets T=Q*j*k, the LTE terminal or the LTE module may detect, when performing sorting based on an RSSI, an RSSI of a resource occupied by NR, to make it less easily to select a resource in the NR resource pool.

When the reservation period T of the first terminal meets T=Q*j*k, the reserved resource of the terminal can still be aligned with a subframe, and an AGC problem is not caused by misalignment.

Optionally, a physical sidelink feedback channel (PSFCH) of the first terminal meets at least one of the following that: a period of the PSFCH is configured as k, a PSFCH occasion is located in an end slot of an aggregated resource, or the PSFCH occasion and the aggregated resource correspond to the last slot of a same LTE subframe. The aggregated resource is NR resources in a plurality of consecutive slots. Optionally, an index of the end slot of the aggregated resource meets the second rule.

Optionally, when the PSFCH of the first terminal meets the foregoing condition, the first SCS may be 60 KHz. In this way, it can be ensured that transmission of the PSFCH does not interfere with LTE transmission.

Optionally, the PSFCH occasion may be located in a slot whose index meets the second rule.

Optionally, in this embodiment of this application, in a case that a start slot of an NR resource meets the first rule, and a time domain start location of the NR resource is aligned with a time domain start location of an LTE subframe in the LTE resource pool, an AGC symbol in the start slot of the NR resource is time-domain multiplexed with an AGC symbol in the LTE subframe.

Optionally, the NR resource pool may include a first subset and a second subset. In other words, the first subset and the second subset dynamically coexist.

When the first terminal determines a transmission resource in the first subset, the first resource includes k slots.

When the first terminal determines the transmission resource in the second subset, the first resource includes one slot.

Optionally, when the first terminal determines that NR SL transmission may affect LTE SL transmission, for example, determines, based on the LTE resource pool information, that NR SL transmission may affect LTE SL transmission, the first terminal may select the first resource from the first subset for transmission. When the first terminal determines that NR SL transmission does not affect or slightly affect LTE SL transmission, the first terminal may select the first resource from the second subset for transmission.

Optionally, the first terminal determines to execute a resource selection manner 1 in the first subset and execute a resource selection manner 2 in the second subset.

The resource selection manner 1 is a resource selection manner or sending manner similar to that for multi consecutive slots transmission (MCSt) mentioned above. The resource selection manner 2 is a resource selection manner or sending manner reusing an existing standard (such as reuse legacy). In other words, the first terminal determines, based on a selected resource or a detected resource, whether to use a resource selection manner for MCSt.

For example, the resource selection manner for MCSt may consider the period reservation manner, the subframe alignment manner, the PSFCH location that are described above, and other limitations.

For example, the resource selection manner for MCSt may be considering the period reservation manner, the subframe alignment manner, the PSFCH location, and other limitations.

In this way, because the NR resource pool includes the first subset and the second subset, the first terminal may accurately select a resource and perform NR SL transmission based on an actual situation of LTE SL transmission in an environment, thereby improving flexibility of NR SL transmission.

Optionally, a resource in the first subset and a resource in the second subset are determined by at least one of the following: a network configuration; a network preconfiguration; determined by the first terminal based on the second information; or determined by the first terminal based on a transmission priority.

Optionally, the first terminal determines the resource in the first subset based on the second information and the first rule.

For example, a specific quantity of resources in the second subset is initially configured in the NR resource pool. Then, the first terminal may determine, based on information related to LTE, such as the LTE resource pool information, whether to update a resource type in the NR resource pool, to adapt to a change in a service or the like.

Optionally, after determining that the second information meets a condition at time h, M resources located in the second subset after time h+E are updated to resources in the first subset. The M resources in the second subset may be any one of the following:
M resources that are adjacent to existing resources in the first subset in time domain; or
N*k consecutive resources in at least one period in which the existing resources in the first subset are periodically distributed in time domain,
where h, E, and K are greater than or equal to 0, and M and N are positive integers.

In this way, the resource in the first subset and the resource in the second subset may be determined in different manners, thereby improving flexibility of determining resources dynamically coexisting in a resource pool.

Optionally, the resource in the first subset meets at least one of the following:

(i) Periodic distribution.

For example, there are N*k slots in every W slots. A main purpose is to ensure that a resource reserved in the first subset is still a resource of a part B, so as to prevent a conflict caused by a different resource selection manner or a different sending manner.

W is a reservation period allowed in the first subset, N*k is used to facilitate alignment with an LTE subframe in the LTE resource pool, and N is a positive integer.

(ii) An AGC symbol in a start slot of each resource is aligned with an AGC symbol in an LTE subframe in the LTE resource pool.

Alternatively, a start boundary of each resource is aligned with a start boundary or a start boundary of an LTE subframe in the LTE resource pool.

(iii) A time domain start location of the resource is aligned with a time domain start location of an LTE subframe in the LTE resource pool.

It should be noted that, determining the NR resource pool is a prerequisite for the terminal to perform NR SL communication and is a basis for all, and therefore may be performed at the earliest time. Selecting a transmission resource is the last step of a resource selection process, and is performed by a MAC layer. The rest all belong to a physical layer process of the resource selection process. For other descriptions of the resource selection process, refer to related descriptions in a current technology.

The following describes, with reference to come examples, the SL transmission method provided in the embodiments of this application.

Example 1: When an NR RAT performs transmission by using an SCS of higher than 15 KHz, for example, when the first SCS=30 KHz, an AGC problem may occur in simultaneous LTE transmissions. In this case, a multi-slots technology may be introduced. However, the multi-slots technology does not emphasize a boundary of NR transmission, which needs to be resolved in coexistence, because if a boundary of multi-slots transmission is not aligned with that of an LTE subframe, the foregoing AC problem can still be caused.

One method is to first determine an NR resource pool that completely overlaps with the LTE resource pool in time domain, as shown in FIG. 4. In this case, because the NR resource pool and the LTE resource pool completely overlap in time domain, as long as a number of a logical slot of the first terminal is an even number, a start location of the logical slot necessarily corresponds to a start location of an LTE subframe. In other words, as long as the first terminal uses a slot whose index is an even number as a start slot when selecting a resource, and then continuously selects an even quantity of slots as candidate resources, an AGC problem on an LTE terminal side can be avoided.

Optionally, to obtain an NR resource pool completely overlaps with the LTE resource pool in time domain, the first terminal may determine the NR resource pool based on the LTE resource pool information.

Example 2: Considering that it is difficult to construct an NR resource pool that completely overlaps with the LTE resource pool in time domain due to a relatively large quantity of conditions required in this case, for example, a synchronization signal of an NR RAT and a synchronization signal of an LTE RAT need to be located outside the resource pool, and TDD configurations of the NR RAT and the LTE RAT also need to be the same, to construct an NR resource pool that completely overlaps with the LTE resource pool in time domain, a more easy construction manner may be considered.

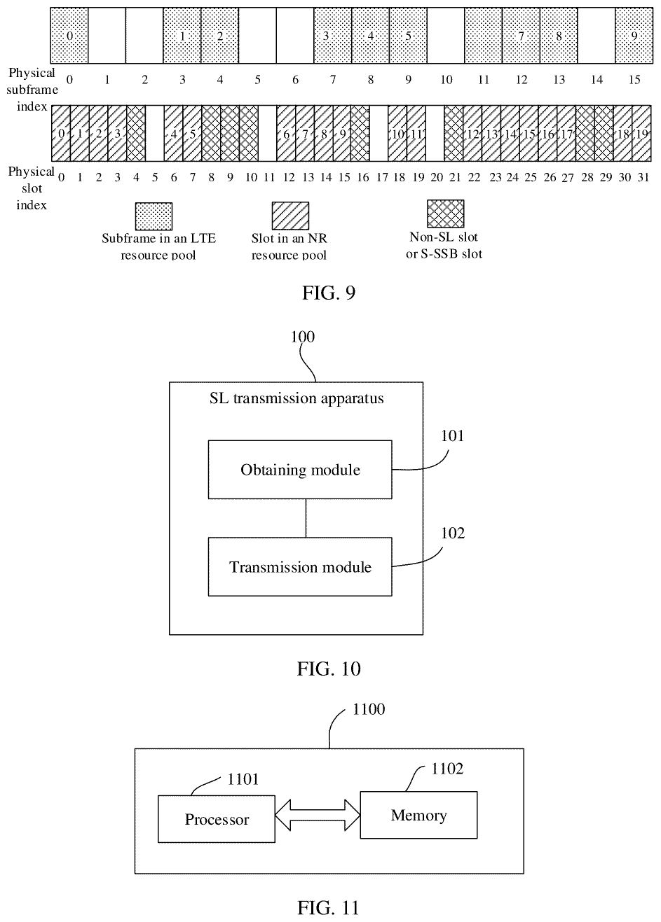

For physical subframes not included in the LTE resource pool for various reasons, for example, subframes with indexes of 1, 2, 5, 6, 10, and 14 shown in FIG. 9, if NR SL transmission can use the subframes and the NR resource pool can fully use the subframes, the NR resource pool can include resources in these physical subframes, for example, physical slots slot 2 and slot 3 corresponding to a physical subframe 1 shown in FIG. 9.

If the NR resource pool cannot use a specific subframe for some reason, for example, physical subframes 4 and 14 in FIG. 9, or cannot use an entire subframe, for example, physical subframes 2, 5, and 10 in FIG. 9, the NR resource pool does not include slots corresponding to these subframes.

Optionally, after the NR resource pool is determined in the manner in Example 2, to align a boundary of an NR resource with that of an LTE subframe, the first terminal may determine, from the resource pool, that an index of a start slot of a transmission resource meets index mod k=0.

Example 3: It may be learned that, when the NR resource pool is constructed in both Example 1 and Example 2, boundary alignment between an NR resource and an LTE resource is performed, that is, an NR resource in the NR resource pool is determined on a premise that LTE SL transmission is not affected.

In actual implementation, whether LTE SL transmission is affected is not considered in a construction process of the NR resource pool, but in a resource selection process, impact on LTE SL transmission is excluded, that is, resource boundary alignment is ensured.

For example, when the first terminal selects a resource with an aggregated slot (the candidate resource includes a plurality of slots), the first terminal may exclude, based on the LTE resource pool information when constructing the candidate resource set, a candidate resource in resources in the NR resource pool or the candidate resource set that is not aligned (or partially aligned) with a boundary of a subframe in the LTE resource pool. The resource excluding process may also be performed in another step of resource selection, for example, performed before reporting to the MAC layer.

Optionally, if a quantity of candidate resources in the candidate resource set is relatively small after resource excluding is performed by using the RSRP and the third threshold, the threshold of the RSRP may be increased from the third threshold to the second threshold, and the candidate resource set and a subsequent step are re-initialized, until a quantity or a proportion of candidate resources in a final candidate resource set meets a requirement.

Optionally, the first terminal may ensure resource boundary alignment at the MAC layer. For example, when a resource is finally selected at the MAC layer, a resource whose resource boundary is aligned with that of an LTE subframe or a resource that completely does not overlap with the LTE resource pool in time domain needs to be selected as a transmission resource, to avoid an AGC problem.

Optionally, if the first terminal still reuses the R16/R17 design, that is, the candidate resource still includes only one slot, the MAC layer may ensure resource boundary alignment. For example, when a resource is finally selected at the MAC layer, a plurality of consecutive candidate resources whose resource boundaries are aligned with that of an LTE subframe or candidate resources that completely do not overlap with the LTE resource pool in time domain needs to be selected as transmission resources, to avoid an AGC problem.

In this way, the SL transmission method provided in the embodiments of this application is used to ensure that in different SCS scenarios, the LTE RAT and the NR RAT can avoid, by using the multi-slots mechanism, a problem that LTE transmission is interfered with by different power of the NR RAT on different symbols, causing inaccurate AGC to affect transmission reliability.

The SL transmission method provided in the embodiments of this application may be performed by an SL transmission apparatus. In the embodiments of this application, the SL transmission apparatus provided in the embodiments of this application is described by using an example in which the SL transmission apparatus performs the SL transmission method.

An embodiment of this application provides an SL transmission apparatus. FIG. 10 is a schematic diagram of a structure of an SL transmission apparatus according to an embodiment of this application. As shown in FIG. 10, the SL transmission apparatus 100 may include an obtaining module 101 and a transmission module 102.

The obtaining module 101 is configured to obtain long term evolution LTE resource pool information. The transmission module 102 is configured to perform new radio NR SL transmission based on the LTE resource pool information obtained by the obtaining module 101. The LTE resource pool information includes at least one of the following: an LTE resource pool configuration, a location of a resource in an LTE resource pool, or a boundary of an LTE subframe in the LTE resource pool.

In a possible implementation, the obtaining module 101 is configured to: receive the LTE resource pool information, or determine the LTE resource pool information based on first information.

The first information includes at least one of the following:
an LTE time division duplex TDD configuration;
an LTE synchronization signal location;
an inter-UE coordination IUC indication; or
a first measurement quantity.

The first measurement quantity includes at least one of the following: a received signal strength indication RSSI or a reference signal received power RSRP.

In a possible implementation, the first information includes the first measurement quantity; and the obtaining module 101 is configured to determine a boundary of an LTE subframe in the LTE resource pool based on the first measurement quantity.

In a possible implementation, the transmission module 102 includes a processing submodule and a transmission module.

The processing submodule is configured to select a first resource from an NR resource pool based on the LTE resource pool information.

The transmission module is configured to perform NR SL transmission by using the first resource selected by the processing submodule.

The first resource meets a first condition, and the first condition includes at least one of the following that:
the first resource is not time-domain multiplexed with all LTE subframes in the LTE resource pool;
the first resource is fully time-domain multiplexed with an LTE subframe in the LTE resource pool;
the first measurement quantity of the first resource is less than or equal to a first threshold, and the first measurement quantity includes at least one of the following: an RSSI or an RSRP;
an index of a start slot of the first resource meets a first rule;
an index of an end slot of the first resource meets a second rule;
the first resource does not conflict with a reserved resource; or
an AGC symbol in the start slot of the first resource is time-domain multiplexed with an AGC symbol in an LTE subframe in the LTE resource pool.

The first rule includes that a remainder obtained by dividing an index by k is q, and the second rule includes that a remainder obtained by dividing an index by k is p, where
k is determined by a ratio of a first sub-carrier spacing SCS to a second SCS, the first SCS is an SCS used by the first terminal, the second SCS is an SCS used by an LTE radio access technology RAT, and k, p, and q are integers.

In a possible implementation, the processing submodule is configured to: determine a candidate resource set from the NR resource pool, and select the first resource from the candidate resource set.

A unit of a candidate resource in the candidate resource set is k slots or one slot.

Optionally, when the unit of the candidate resource is k slots, an index of a start slot of the candidate resource meets the first rule.

In a possible implementation, the unit of the candidate resource is determined by second information.

The second information includes at least one of the following: a second measurement quantity, a downlink control information DCI indication, SCI, a resource pool preconfiguration, a resource pool configuration, a network preconfiguration, a network configuration, a synchronization source type, synchronization signal strength, or a first indication.

The second measurement quantity includes at least one of the following: a channel busy ratio CBR, a channel occupation ratio CR, an SCI detection amount, an RSRP, an RSSI, or a synchronization signal-reference signal received power SS-RSRP.

The first indication includes at least one of an IUC collision indication or a coexistence indication.

The IUC conflict indication is used to indicate that NR SL transmission of at least one NR terminal conflicts with LTE SL transmission; and
the coexistence indication is used to indicate that at least one NR terminal or LTE terminal coexists with an LTE terminal.

In a possible implementation, the processing submodule is configured to perform at least one of the following:
in a case that the unit of the candidate resource in the candidate resource set is k slots, determining a candidate resource that meets a second condition in the candidate resource set as the first resource; or
in a case that the unit of the candidate resource in the candidate resource set is one slot, determining k candidate resources whose indexes are consecutive in the candidate resource set as the first resource.

The second condition includes at least one of the following that:
the candidate resource is fully time-domain multiplexed with an LTE subframe in the LTE resource pool;
an index of a start slot meets the first rule; or
an index of an end slot meets the second rule.

In a possible implementation, the k candidate resources meet a third condition, and the third condition includes at least one of the following that:
an automatic gain control AGC symbol of the 1-st candidate resource is time-domain multiplexed with an AGC symbol in an LTE subframe in the LTE resource pool;
an index of the 1-st candidate resource meets the first rule; or
an index of the last candidate resource meets the second rule.

In a possible implementation, the processing submodule is configured to determine a candidate resource from the NR resource pool in a first manner.

The first manner includes at least one of the following that:
the candidate resource includes L subchannels in k slots;
in a case that the NR resource pool is fully time-domain multiplexed with the LTE resource pool, the candidate resource includes L subchannels in k consecutive slots with a start slot having an index t;
in a case that the NR resource pool is not time-domain multiplexed with the LTE resource pool, the candidate resource includes L subchannels in one slot; or
in a case that the NR resource pool is partially time-domain multiplexed with the LTE resource pool, a candidate resource in a first time domain range includes L subchannels in k consecutive slots with a start slot having an index r, and a candidate resource in a second time domain range includes L subchannels in one slot.

The first time domain range is a time domain range in which the NR resource pool and the LTE resource pool overlap in time domain; and
the second time domain range is a time domain range in which the NR resource pool and the LTE resource pool do not overlap in time domain, t, r, and L all are integers greater than or equal to 0, and r and t meet the first rule.

In a possible implementation, the processing submodule is further configured to: before selecting the first resource from the candidate resource set, exclude, from the candidate resource set, a candidate resource that meets a fourth condition.

The fourth condition includes one of the following:
the candidate resource is at least partially time-domain multiplexed with a first reserved resource indicated by first SCI;
a slot of the candidate resource includes a slot of a reserved resource indicated by second SCI;
the candidate resource multiplexes a same LTE subframe as the reserved resource indicated by the second SCI;
the candidate resource is located in a same aggregated resource as the reserved resource indicated by the second SCI;
the candidate resource corresponds to a same start slot as the reserved resource indicated by the second SCI, where an index of the start slot of the resource meets the first rule;
the candidate resource corresponds to a same slot range as the reserved resource indicated by the second SCI, where quotients obtained by dividing indexes of slots in the same slot range by k are the same; or
the candidate resource is partially time-domain multiplexed with an LTE subframe in the LTE resource pool.

The first SCI and the second SCI are SCI detected by the first terminal;
an RSRP of the first SCI is greater than or equal to a second threshold, and the first reserved resource is not time-domain multiplexed with all the LTE subframes in the LTE resource pool; and
the aggregated resource includes NR resources in a plurality of consecutive slots.

In a possible implementation, a resource indication of the SL transmission apparatus meets at least one of the following that:
at least one of first-stage SCI or second-stage SCI is sent in a start slot of a transmission resource;
a time domain location indicated by a time resource indication value TRIV carried in SCI is a time domain location of a candidate resource indicated by the SCI;
the SCI carries a second indication, where the second indication is used to indicate that a current slot is located in which slot of the candidate resource; or
a reservation period T of the SL transmission apparatus meets at least one of the following: T=Q*j*k, or T=j*k.

Q includes one of a step in the TDD configuration and an LTE-configurable reservation period, and j is an integer not less than 0.

In a possible implementation, a physical sidelink feedback channel PSFCH of the SL transmission apparatus 100 meets at least one of the following that: a period of the PSFCH is configured as k, or a PSFCH occasion is located in an end slot of an aggregated resource.

The aggregated resource is NR resources in a plurality of consecutive slots.

In a possible implementation, an index of an end slot of the aggregated resource meets the second rule.

In a possible implementation, in a case that a start slot of an NR resource meets the first rule, and a time domain start location of the NR resource is aligned with a time domain start location of an LTE subframe in the LTE resource pool, an AGC symbol in the start slot of the NR resource is time-domain multiplexed with an AGC symbol in the LTE subframe.

In a possible implementation, the transmission submodule is configured to perform NR SL transmission based on a first transmission policy by using the first resource.

The first transmission policy includes at least one of the following that:
a gap symbol between slots is used to send a physical sidelink shared channel PSSCH or virtual data;
transport blocks TBs in different slots are sent to a same destination terminal; or
when TBs in different slots are sent to different destination terminals, transmit power of the TBs remains consistent.

In a possible implementation, in a case that TBs in different slots are sent to a same destination terminal, another slot that is in the first resource and that is different from a slot in which initially transmitted data is sent is used for blind retransmission.

In a possible implementation, the NR resource pool includes a first subset and a second subset;
when the first terminal determines a transmission resource in the first subset, the first resource includes k slots; and
when the first terminal determines the transmission resource in the second subset, the first resource includes one slot.

In a possible implementation, a resource in the first subset and a resource in the second subset are determined by at least one of the following: a network configuration; a network preconfiguration; determined based on the second information; or determined based on a transmission priority.

In a possible implementation, the resource in the first subset meets at least one of the following:
periodic distribution;
that an AGC symbol in a start slot of each resource is aligned with an AGC symbol in an LTE subframe in the LTE resource pool; or
that a time domain start location of the resource is aligned with a time domain start location of an LTE subframe in the LTE resource pool.

In the SL transmission apparatus provided in this embodiment of this application, NR SL transmission may be performed based on the LTE resource pool information. Therefore, it can be ensured that a resource for performing NR SL transmission and an LTE subframe completely overlap or completely do not overlap in time domain, thereby preventing NR SL transmission from affecting LTE SL transmission.

The SL transmission apparatus in this embodiment of this application may be an electronic device, for example, an electronic device with an operating system; or may be a component, for example, an integrated circuit or a chip, in an electronic device. The electronic device may be a terminal, or may be another device different from a terminal. For example, the terminal may include but is not limited to the foregoing listed types of the terminal 11. The another device may be a server, a network attached storage (NAS), or the like. This is not limited in this embodiment of this application.

The SL transmission apparatus provided in this embodiment of this application can implement the processes implemented in the method embodiments of FIG. 2 to FIG. 9, and achieve the same technical effects. To avoid repetition, details are not described herein again.

As shown in FIG. 11, an embodiment of this application further provides a terminal 1100, including a processor 1101 and a memory 1102. The memory 1102 stores a program or instructions executable on the processor 1101. For example, when the program or the instructions are executed by the processor 1101, the steps in the foregoing embodiments of the SL transmission method are implemented, and the same technical effects can be achieved.

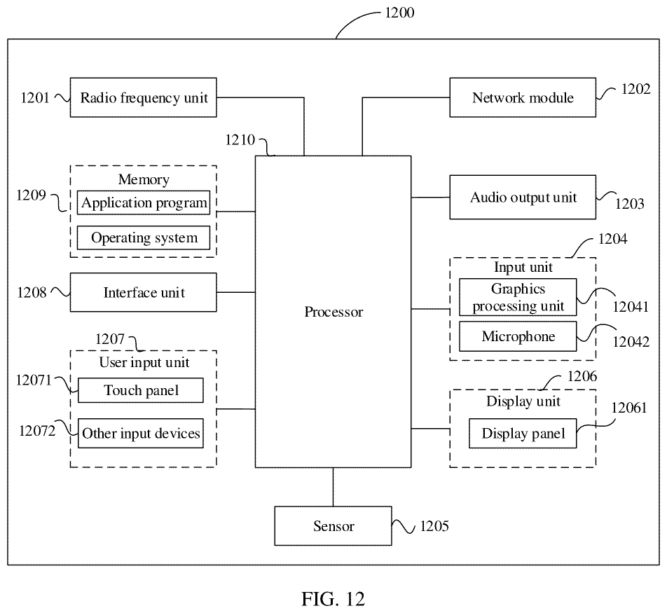

An embodiment of this application further provides a terminal, including a processor and a communication interface. The communication interface is coupled to the processor. The processor is configured to run a program or instructions to implement the steps in the method embodiments shown in FIG. 2 to FIG. 9. The terminal embodiment corresponds to the foregoing terminal-side method embodiment. Each implementation process and implementation of the foregoing method embodiment may be applied to the terminal embodiment, and the same technical effects can be achieved. Optionally, FIG. 12 is a schematic diagram of a hardware structure of a terminal for implementing an embodiment of this application.

The terminal 1200 includes but is not limited to at least some components of a radio frequency unit 1201, a network module 1202, an audio output unit 1203, an input unit 1204, a sensor 1205, a display unit 1206, a user input unit 1207, an interface unit 1208, a memory 1209, a processor 1210, and the like.

A person skilled in the art may understand that the terminal 1200 may further include a power supply (for example, a battery) that supplies power to each component. The power supply may be logically connected to the processor 1210 by using a power management system, to implement functions such as charging management, discharging management, and power consumption management through the power management system. The structure of the terminal shown in FIG. 12 does not constitute a limitation on the terminal. The terminal may include more or fewer components than those shown in the figure, or combine some components, or have different component arrangements. Details are not described herein again.

It should be understood that in this embodiment of this application, the input unit 1204 may include a graphics processing unit (GPU) 12041 and a microphone 12042. The graphics processing unit 12041 processes image data of a still picture or a video obtained by an image capture apparatus (for example, a camera) in a video capture mode or an image capture mode. The display unit 1206 may include a display panel 12061, and the display panel 12061 may be configured in a form of a liquid crystal display, an organic light-emitting diode, or the like. The user input unit 1207 includes at least one of a touch panel 12071 or other input devices 12072. The touch panel 12071 is also referred to as a touchscreen. The touch panel 12071 can include two parts: a touch detection apparatus and a touch controller. The other input devices 12072 may include but are not limited to a physical keyboard, a function key (such as a volume control key or an on/off key), a trackball, a mouse, and a joystick. Details are not described herein again.

In this embodiment of this application, after receiving downlink data from a network-side device, the radio frequency unit 1201 may transmit the downlink data to the processor 1210 for processing. In addition, the radio frequency unit 1201 may send uplink data to a network-side device. Generally, the radio frequency unit 1201 includes but is not limited to an antenna, an amplifier, a transceiver, a coupler, a low-noise amplifier, a duplexer, and the like.

The memory 1209 may be configured to store a software program or instructions and various types of data. The memory 1209 may mainly include a first storage area for storing a program or instructions and a second storage area for storing data. The first storage area may store an operating system, an application program or instructions required by at least one function (for example, a sound play function or an image play function), and the like. In addition, the memory 1209 may include a volatile memory or a nonvolatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DRRAM). The memory 1209 in this embodiment of this application includes but is not limited to these memories and any other suitable type of memory.

The processor 1210 may include one or more processing units. Optionally, the processor 1210 integrates an application processor and a modem processor. The application processor mainly processes operations related to an operating system, a user interface, an application program, and the like. The modem processor, for example, a baseband processor, mainly processes a wireless communication signal. It may be understood that, the foregoing modem processor may not be integrated into the processor 1210.

The processor 1210 is configured to obtain LTE resource pool information. The radio frequency unit 1201 is configured to perform NR SL transmission based on the LTE resource pool information obtained by the processor 1210. The LTE resource pool information includes at least one of the following: an LTE resource pool configuration, a location of a resource in an LTE resource pool, or a boundary of an LTE subframe in the LTE resource pool.

In a possible implementation, the processor 1210 is configured to: receive the LTE resource pool information, or determine the LTE resource pool information based on first information.

The first information includes at least one of the following that:
an LTE time division duplex TDD configuration;
an LTE synchronization signal location;
an inter-UE coordination IUC indication; or
a first measurement quantity.

The first measurement quantity includes at least one of the following: a received signal strength indication RSSI or a reference signal received power RSRP.

In a possible implementation, the first information includes the first measurement quantity; and
the processor 1210 is configured to determine a boundary of an LTE subframe in the LTE resource pool based on the first measurement quantity.

In a possible implementation, the processor 1210 is configured to select a first resource from an NR resource pool based on the LTE resource pool information; and
a transmission module is configured to perform NR SL transmission by using the first resource selected by the processor 1210.

The first resource meets a first condition, and the first condition includes at least one of the following that:
the first resource is not time-domain multiplexed with all LTE subframes in the LTE resource pool;
the first resource is fully time-domain multiplexed with an LTE subframe in the LTE resource pool;
the first measurement quantity of the first resource is less than or equal to a first threshold, and the first measurement quantity includes at least one of the following: an RSSI or an RSRP;
an index of a start slot of the first resource meets a first rule;
an index of an end slot of the first resource meets a second rule;
the first resource does not conflict with a reserved resource; or
an AGC symbol in the start slot of the first resource is time-domain multiplexed with an AGC symbol in an LTE subframe in the LTE resource pool.

The first rule includes that a remainder obtained by dividing an index by k is q, and the second rule includes that a remainder obtained by dividing an index by k is p, where
k is determined by a ratio of a first sub-carrier spacing SCS to a second SCS, the first SCS is an SCS used by the terminal, the second SCS is an SCS used by an LTE radio access technology RAT, and k, p, and q are integers.

In a possible implementation, the processor 1210 is configured to: determine a candidate resource set from the NR resource pool, and select the first resource from the candidate resource set.

A unit of a candidate resource in the candidate resource set is k slots or one slot.

Optionally, when the unit of the candidate resource is k slots, an index of a start slot of the candidate resource meets the first rule.

In a possible implementation, the unit of the candidate resource is determined by second information.

The second information includes at least one of the following: a second measurement quantity, a downlink control information DCI indication, SCI, a resource pool preconfiguration, a resource pool configuration, a network preconfiguration, a network configuration, a synchronization source type, synchronization signal strength, or a first indication.

The second measurement quantity includes at least one of the following: a channel busy ratio CBR, a channel occupation ratio CR, an SCI detection amount, an RSRP, an RSSI, or a synchronization signal-reference signal received power SS-RSRP.

The first indication includes at least one of an IUC collision indication or a coexistence indication.

The IUC conflict indication is used to indicate that NR SL transmission of at least one NR terminal conflicts with LTE SL transmission; and
the coexistence indication is used to indicate that at least one NR terminal or LTE terminal coexists with an LTE terminal.

In a possible implementation, the processor 1210 is configured to perform at least one of the following:
in a case that the unit of the candidate resource in the candidate resource set is k slots, determining a candidate resource that meets a second condition in the candidate resource set as the first resource; or
in a case that the unit of the candidate resource in the candidate resource set is one slot, determining k candidate resources whose indexes are consecutive in the candidate resource set as the first resource.

The second condition includes at least one of the following that:
the candidate resource is fully time-domain multiplexed with an LTE subframe in the LTE resource pool;
an index of a start slot meets the first rule; or
an index of an end slot meets the second rule.

In a possible implementation, the k candidate resources meet a third condition, and the third condition includes at least one of the following that:
an automatic gain control AGC symbol of the 1-st candidate resource is time-domain multiplexed with an AGC symbol in an LTE subframe in the LTE resource pool;
an index of the 1-st candidate resource meets the first rule; or
an index of the last candidate resource meets the second rule.

In a possible implementation, the processor 1210 is configured to determine a candidate resource from the NR resource pool in a first manner.

The first manner includes at least one of the following that:
the candidate resource includes L subchannels in k slots;
in a case that the NR resource pool is fully time-domain multiplexed with the LTE resource pool, the candidate resource includes L subchannels in k consecutive slots with a start slot having an index t;
in a case that the NR resource pool is not time-domain multiplexed with the LTE resource pool, the candidate resource includes L subchannels in one slot; or
in a case that the NR resource pool is partially time-domain multiplexed with the LTE resource pool, a candidate resource in a first time domain range includes L subchannels in k consecutive slots with a start slot having an index r, and a candidate resource in a second time domain range includes L subchannels in one slot.

The first time domain range is a time domain range in which the NR resource pool and the LTE resource pool overlap in time domain; and
the second time domain range is a time domain range in which the NR resource pool and the LTE resource pool do not overlap in time domain, t, r, and L all are integers greater than or equal to 0, and r and t meet the first rule.

In a possible implementation, the processor 1210 is further configured to: before selecting the first resource from the candidate resource set, exclude, from the candidate resource set, a candidate resource that meets a fourth condition.

The fourth condition includes one of the following:
the candidate resource is at least partially time-domain multiplexed with a first reserved resource indicated by first SCI;
a slot of the candidate resource includes a slot of a reserved resource indicated by second SCI;
the candidate resource multiplexes a same LTE subframe as the reserved resource indicated by the second SCI;
the candidate resource is located in a same aggregated resource as the reserved resource indicated by the second SCI;
the candidate resource corresponds to a same start slot as the reserved resource indicated by the second SCI, where an index of the start slot of the resource meets the first rule;
the candidate resource corresponds to a same slot range as the reserved resource indicated by the second SCI, where quotients obtained by dividing indexes of slots in the same slot range by k are the same; or
the candidate resource is partially time-domain multiplexed with an LTE subframe in the LTE resource pool.

The first SCI and the second SCI are SCI detected by the first terminal;
an RSRP of the first SCI is greater than or equal to a second threshold, and the first reserved resource is not time-domain multiplexed with all the LTE subframes in the LTE resource pool; and
the aggregated resource includes NR resources in a plurality of consecutive slots.

In a possible implementation, a resource indication of the terminal meets at least one of the following that:
at least one of first-stage SCI or second-stage SCI is sent in a start slot of a transmission resource;
a time domain location indicated by a time resource indication value TRIV carried in SCI is a time domain location of a candidate resource indicated by the SCI;
the SCI carries a second indication, where the second indication is used to indicate that a current slot is located in which slot of the candidate resource; or
a reservation period T of the terminal meets at least one of the following: T=Q*j*k, or T=j*k.

Q includes one of a step in the TDD configuration and an LTE-configurable reservation period, and j is an integer not less than 0.

In a possible implementation, a physical sidelink feedback channel PSFCH of the SL transmission apparatus meets at least one of the following that: a period of the PSFCH is configured as k, or a PSFCH occasion is located in an end slot of an aggregated resource.

The aggregated resource is NR resources in a plurality of consecutive slots.

In a possible implementation, an index of an end slot of the aggregated resource meets the second rule.

In a possible implementation, in a case that a start slot of an NR resource meets the first rule, and a time domain start location of the NR resource is aligned with a time domain start location of an LTE subframe in the LTE resource pool, an AGC symbol in the start slot of the NR resource is time-domain multiplexed with an AGC symbol in the LTE subframe.

In a possible implementation, the processor 1210 is configured to perform NR SL transmission based on a first transmission policy by using the first resource.

The first transmission policy includes at least one of the following that:
a gap symbol between slots is used to send a physical sidelink shared channel PSSCH or virtual data;
transport blocks TBs in different slots are sent to a same destination terminal; or
when TBs in different slots are sent to different destination terminals, transmit power of the TBs remains consistent.

In a possible implementation, in a case that TBs in different slots are sent to a same destination terminal, another slot that is in the first resource and that is different from a slot in which initially transmitted data is sent is used for blind retransmission.

In a possible implementation, the NR resource pool includes a first subset and a second subset;
when the terminal determines a transmission resource in the first subset, the first resource includes k slots; and
when the terminal determines the transmission resource in the second subset, the first resource includes one slot.

In a possible implementation, a resource in the first subset and a resource in the second subset are determined by at least one of the following: a network configuration; a network preconfiguration; determined based on the second information; or determined based on a transmission priority.

In a possible implementation, the resource in the first subset meets at least one of the following:
periodic distribution;
that an AGC symbol in a start slot of each resource is aligned with an AGC symbol in an LTE subframe in the LTE resource pool; or
that a time domain start location of the resource is aligned with a time domain start location of an LTE subframe in the LTE resource pool.

In the terminal provided in this embodiment of this application, NR SL transmission may be performed based on the LTE resource pool information. Therefore, it can be ensured that a resource for performing NR SL transmission and an LTE subframe completely overlap or completely do not overlap in time domain, thereby preventing NR SL transmission from affecting LTE SL transmission.

It may be understood that for implementation processes of the implementations mentioned in this embodiment, reference may be made to related descriptions in the foregoing embodiments of the SL transmission method, and the same or corresponding technical effects are achieved. To avoid repetition, details are not described herein again.

An embodiment of this application further provides a non-transitory readable storage medium. The non-transitory readable storage medium stores a program or instructions. When the program or the instructions are executed by a processor, processes in the foregoing embodiments of the SL transmission method are implemented, and the same technical effects can be achieved. To avoid repetition, details are not described herein again.

The processor is a processor in the terminal in the foregoing embodiments. The non-transitory readable storage medium includes a non-transitory computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing embodiments of the SL transmission method, and the same technical effects can be achieved. To avoid repetition, details are not described herein again.

It should be understood that the chip mentioned in this embodiment of this application can also be referred to as a system-level chip, a system chip, a chip system, a system on chip, or the like.

An embodiment of this application further provides a computer program/program product. The computer program/program product is stored in a non-transitory storage medium. The computer program/program product is executed by at least one processor to implement processes in the foregoing embodiments of the SL transmission method, and the same technical effects can be achieved. To avoid repetition, details are not described herein again.

It should be noted that in this specification, the term “comprise”, “include”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that the scope of the method and apparatus in the implementations of this application is not limited to performing functions in an order shown or discussed, and may further include performing functions in a basically simultaneous manner or in reverse order based on the functions involved. For example, the described method may be performed in an order different from the described order, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by a computer software product and a necessary general-purpose hardware platform, or certainly may be implemented by hardware. The computer software product is stored in a non-transitory storage medium (such as a ROM, a RAM, a magnetic disk, or an optical disc) and includes several instructions for instructing a terminal or a network-side device to perform the methods described in the embodiments of this application.

The foregoing describes the embodiments of this application with reference to the accompanying drawings. However, this application is not limited to the foregoing implementations. The foregoing implementations are merely illustrative rather than restrictive. Inspired by this application, a person of ordinary skill in the art may develop many forms of implementations without departing from principles of this application and the protection scope of the claims, and all such implementations fall within the protection scope of this application.

What is claimed is:

1. A sidelink (SL) transmission method, comprising:
obtaining, by a first terminal, long term evolution (LTE) resource pool information; and
performing, by the first terminal, new radio (NR) SL transmission based on the LTE resource pool information,
wherein the LTE resource pool information comprises at least one of the following: an LTE resource pool configuration, a location of a resource in an LTE resource pool, or a boundary of an LTE subframe in the LTE resource pool.

2. The method according to claim 1, wherein the obtaining, by a first terminal, LTE resource pool information comprises at least one of the following:
receiving, by the first terminal, the LTE resource pool information; or
determining, by the first terminal, the LTE resource pool information based on first information,
wherein the first information comprises at least one of the following:
an LTE time division duplex (TDD) configuration;
an LTE synchronization signal location;
an inter-UE coordination (IUC) indication; or
a first measurement quantity,
wherein the first measurement quantity comprises at least one of the following: a received signal strength indication (RSSI) or a reference signal received power (RSRP).

3. The method according to claim 1, wherein the performing, by the first terminal, NR SL transmission based on the LTE resource pool information comprises:
selecting, by the first terminal, a first resource from an NR resource pool based on the LTE resource pool information; and
performing, by the first terminal, the NR SL transmission by using the first resource,
wherein the first resource meets a first condition, and the first condition comprises at least one of the following that:
the first resource is not time-domain multiplexed with all LTE subframes in the LTE resource pool;
the first resource is fully time-domain multiplexed with an LTE subframe in the LTE resource pool;
a first measurement quantity of the first resource is less than or equal to a first threshold, and the first measurement quantity comprises at least one of the following: a received signal strength indication (RSSI) or a reference signal received power (RSRP);
an index of a start slot of the first resource meets a first rule;
an index of an end slot of the first resource meets a second rule;
the first resource does not conflict with a reserved resource; or
start location of an automatic gain control (AGC) symbol of the first resource is aligned with start location of an AGC symbol in an LTE subframe in the LTE resource pool,
wherein the first rule comprises that a remainder obtained by dividing an index by k is q, and the second rule comprises that a remainder obtained by dividing an index by k is p; and
k is determined by a ratio of a first sub-carrier spacing (SCS) to a second SCS, the first SCS is an SCS used by the first terminal, the second SCS is an SCS used by an LTE radio access technology (RAT), and k, p, and q are integers.

4. The method according to claim 3, wherein the selecting, by the first terminal, a first resource from an NR resource pool based on the LTE resource pool information comprises:
determining, by the first terminal, a candidate resource set from the NR resource pool; and
selecting, by the first terminal, the first resource from the candidate resource set,
wherein a unit of a candidate resource in the candidate resource set is k slots or one slot.

5. The method according to claim 4, wherein the unit of the candidate resource is determined by second information;
the second information comprises at least one of the following: a second measurement quantity, a downlink control information (DCI) indication, sidelink control information (SCI), a resource pool preconfiguration, a resource pool configuration, a network preconfiguration, a network configuration, a synchronization source type, synchronization signal strength, or a first indication;
the second measurement quantity comprises at least one of the following: a channel busy ratio (CBR), a channel occupation ratio (CR), an SCI detection amount, an RSRP, an RSSI, or a synchronization signal-reference signal received power (SS-RSRP);
the first indication comprises at least one of an inter-UE coordination (IUC) collision indication or a coexistence indication;
the IUC conflict indication is used to indicate that NR SL transmission of at least one NR terminal conflicts with LTE SL transmission; and
the coexistence indication is used to indicate that at least one NR terminal or LTE terminal coexists with an LTE terminal.

6. The method according to claim 4, wherein the selecting, by the first terminal, the first resource from the candidate resource set comprises at least one of the following:
in a case that the unit of the candidate resource in the candidate resource set is k slots, determining, by the first terminal, a candidate resource that meets a second condition in the candidate resource set as the first resource; or
in a case that the unit of the candidate resource in the candidate resource set is one slot, determining, by the first terminal, k candidate resources whose indexes are consecutive in the candidate resource set as the first resource,
wherein the second condition comprises at least one of the following that:
the candidate resource is fully time-domain multiplexed with an LTE subframe in the LTE resource pool;
an index of a start slot meets the first rule; or
an index of an end slot meets the second rule.

7. The method according to claim 6, wherein the k candidate resources meet a third condition, and the third condition comprises at least one of the following that:
an automatic gain control AGC symbol of a 1-st candidate resource is time-domain multiplexed with an AGC symbol in an LTE subframe in the LTE resource pool;
an index of the 1-st candidate resource meets the first rule; or
an index of a last candidate resource meets the second rule.

8. The method according to claim 4, wherein the determining, by the first terminal, a candidate resource set from the NR resource pool comprises:
determining, by the first terminal, a candidate resource from the NR resource pool in a first manner,
wherein the first manner comprises at least one of the following that:
the candidate resource comprises L subchannels in k slots;
in a case that the NR resource pool is fully time-domain multiplexed with the LTE resource pool, the candidate resource comprises L subchannels in k consecutive slots with a start slot having an index t;
in a case that the NR resource pool is not time-domain multiplexed with the LTE resource pool, the candidate resource comprises L subchannels in one slot; or
in a case that the NR resource pool is partially time-domain multiplexed with the LTE resource pool, a candidate resource in a first time domain range comprises L subchannels in k consecutive slots with a start slot having an index r, and a candidate resource in a second time domain range comprises L subchannels in one slot,
wherein the first time domain range is a time domain range in which the NR resource pool and the LTE resource pool overlap in time domain; and
the second time domain range is a time domain range in which the NR resource pool and the LTE resource pool do not overlap in time domain, t, r, and L all are integers greater than or equal to 0, and r and t meet the first rule.

9. The method according to claim 4, wherein before the selecting, by the first terminal, the first resource from the candidate resource set, the method further comprises:
excluding, by the first terminal from the candidate resource set, a candidate resource that meets a fourth condition,
wherein the fourth condition comprises one of the following that:
the candidate resource is at least partially time-domain multiplexed with a first reserved resource indicated by first sidelink control information (SCI);
a slot of the candidate resource comprises a slot of a reserved resource indicated by second SCI;
the candidate resource multiplexes a same LTE subframe as the reserved resource indicated by the second SCI;
the candidate resource is located in a same aggregated resource as the reserved resource indicated by the second SCI;
the candidate resource corresponds to a same start slot as the reserved resource indicated by the second SCI, wherein an index of the start slot of the resource meets the first rule;
the candidate resource corresponds to a same slot range as the reserved resource indicated by the second SCI, wherein quotients obtained by dividing indexes of slots in the same slot range by k are the same; or
the candidate resource is partially time-domain multiplexed with an LTE subframe in the LTE resource pool,
wherein the first SCI and the second SCI are SCI detected by the first terminal;
an RSRP of the first SCI is greater than or equal to a second threshold, and the first reserved resource is not time-domain multiplexed with all the LTE subframes in the LTE resource pool; and
the aggregated resource comprises NR resources in a plurality of consecutive slots.

10. The method according to claim 3, wherein a resource indication of the first terminal meets at least one of the following that:
at least one of first-stage sidelink control information (SCI) or second-stage SCI is sent in a start slot of the first resource;
a time domain location indicated by a time resource indication value (TRIV) carried in SCI is a time domain location of a candidate resource indicated by the SCI;
the SCI carries a second indication, wherein the second indication is used to indicate that a current slot is located in which slot of the candidate resource; or
a reservation period T of the first terminal meets at least one of the following: T=Q*j*k, or T=j*k,
wherein Q comprises one of a step in an time division duplex (TDD) configuration and an LTE-configurable reservation period, and j is an integer not less than 0.

11. The method according to claim 3, wherein a physical sidelink feedback channel (PSFCH) of the first terminal meets at least one of the following that: a period of the PSFCH is configured as k, or a PSFCH occasion is located in an end slot of an aggregated resource; and
the aggregated resource is NR resources in a plurality of consecutive slots;
wherein an index of the end slot of the aggregated resource meets the second rule.

12. The method according to claim 3, wherein in a case that a start slot of an NR resource meets the first rule, and a time domain start location of the NR resource is aligned with a time domain start location of an LTE subframe in the LTE resource pool, an AGC symbol in the start slot of the NR resource is time-domain multiplexed with an AGC symbol in the LTE subframe.

13. The method according to claim 3, wherein the performing, by the first terminal, NR SL transmission by using the first resource comprises:
performing, by the first terminal, NR SL transmission based on a first transmission policy by using the first resource,
wherein the first transmission policy comprises at least one of the following that:
a gap symbol between slots is used to send a physical sidelink shared channel (PSSCH) or virtual data;
transport blocks (TBs) in different slots are sent to a same destination terminal; or
when TBs in different slots are sent to different destination terminals, transmit power of the TBs remains consistent;
wherein in a case that TBs in different slots are sent to the same destination terminal, another slot that is in the first resource and that is different from a slot in which initially transmitted data is sent is used for blind retransmission.

14. The method according to claim 3, wherein the NR resource pool comprises a first subset and a second subset;
when the first terminal determines a transmission resource in the first subset, the first resource comprises k slots; and
when the first terminal determines the transmission resource in the second subset, the first resource comprises one slot.

15. The method according to claim 14, wherein a resource in the first subset and a resource in the second subset are determined by at least one of the following:
a network configuration;
a network preconfiguration;
determined by the first terminal based on the second information; or
determined by the first terminal based on a transmission priority.

16. The method according to claim 14, wherein the resource in the first subset meets at least one of the following:
periodic distribution;
that an AGC symbol in a start slot of each resource is aligned with an AGC symbol in an LTE subframe in the LTE resource pool; or
that a time domain start location of the resource is aligned with a time domain start location of an LTE subframe in the LTE resource pool.

17. A terminal, comprising a processor and a memory, wherein the memory stores a program or instructions executable on the processor, and the program or the instructions, when executed by the processor, cause the terminal to perform:
obtaining long term evolution (LTE) resource pool information; and
performing new radio (NR) SL transmission based on the LTE resource pool information,
wherein the LTE resource pool information comprises at least one of the following: an LTE resource pool configuration, a location of a resource in an LTE resource pool, or a boundary of an LTE subframe in the LTE resource pool.

18. The terminal according to claim 17, wherein the program or the instructions, when executed by the processor, cause the terminal to perform at least one of the following:
receiving the LTE resource pool information; or
determining the LTE resource pool information based on first information,
wherein the first information comprises at least one of the following:
an LTE time division duplex (TDD) configuration;
an LTE synchronization signal location;
an inter-UE coordination (IUC) indication; or
a first measurement quantity,
wherein the first measurement quantity comprises at least one of the following: a received signal strength indication (RSSI) or a reference signal received power (RSRP).

19. The terminal according to claim 17, wherein the program or the instructions, when executed by the processor, cause the terminal to perform:
selecting a first resource from an NR resource pool based on the LTE resource pool information; and
performing the NR SL transmission by using the first resource,
wherein the first resource meets a first condition, and the first condition comprises at least one of the following that:
the first resource is not time-domain multiplexed with all LTE subframes in the LTE resource pool;
the first resource is fully time-domain multiplexed with an LTE subframe in the LTE resource pool;
a first measurement quantity of the first resource is less than or equal to a first threshold, and the first measurement quantity comprises at least one of the following: a received signal strength indication (RSSI) or a reference signal received power (RSRP);
an index of a start slot of the first resource meets a first rule;
an index of an end slot of the first resource meets a second rule;
the first resource does not conflict with a reserved resource; or
start location of an automatic gain control (AGC) symbol of the first resource is aligned with start location of an AGC symbol in an LTE subframe in the LTE resource pool,
wherein the first rule comprises that a remainder obtained by dividing an index by k is q, and the second rule comprises that a remainder obtained by dividing an index by k is p; and
k is determined by a ratio of a first sub-carrier spacing (SCS) to a second SCS, the first SCS is an SCS used by the first terminal, the second SCS is an SCS used by an LTE radio access technology (RAT), and k, p, and q are integers.

20. A non-transitory readable storage medium, wherein the non-transitory readable storage medium stores a program or instructions, and the program or the instructions, when executed by a processor of a terminal, cause the terminal to perform:
obtaining long term evolution (LTE) resource pool information; and
performing new radio (NR) SL transmission based on the LTE resource pool information,
wherein the LTE resource pool information comprises at least one of the following: an LTE resource pool configuration, a location of a resource in an LTE resource pool, or a boundary of an LTE subframe in the LTE resource pool.
